(19) United States
(12) Patent Application Publication
(10) Pub. No.: US 2017/0361788 A1
(43) Pub. Date: Dec. 21, 2017

(54) WIRE MODULE

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES LTD., Osaka-shi, Osaka (JP)

(72) Inventor: Hideaki Itou, Yokkaichi, Mie (JP)

(21) Appl. No.: 15/544,312

(22) PCT Filed: Jan. 6, 2016
(86) PCT No.: PCT/JP2016/050196

§ 371 Date: Jul. 18, 2017

(30) Foreign Application Priority Data
Jan. 21, 2015 (JP) 2015-009159

(51) Int. Cl. B60R 16/02

(52) U.S. Cl. CPC B60R 16/0215

(57) ABSTRACT

An object of the present invention is to further stabilize the fixed state of a protection member and an electrical wire in a wire module that includes a protection member having a hollow structure. The wire module includes an electrical wire portion and a protection member. The electrical wire portion includes at least one electrical wire. The protection member covers at least a portion of the electrical wire portion in the circumferential direction thereof, and is formed by a hollow plate member that includes a plurality of plate-shaped portions and interposing portions that are arranged between the plate-shaped portions and form hollow spaces between the plate-shaped portions. Also, among the plate-shaped portions of the protection member, an innermost plate-shaped portion that comes into contact with the electrical wire portion is entirely curved in a shape that conforms to the outer circumferential surface of the electrical wire portion.

### CROSS-REFERENCE TO RELATED APPLICATIONS

This application is the U.S. national stage of PCT/JP2016/050196 filed Jan. 6, 2016, which claims priority of Japanese Patent Application No. JP 2015-009159 filed Jan. 21, 2017.

### TECHNICAL FIELD

The present invention relates to a wire module that includes an electrical wire and a protection member.

### BACKGROUND ART

Wire harnesses for installation in a vehicle or the like sometimes include a protection member for protecting electrical wires. The protection member covers at least a portion of the electrical wires in the circumferential direction thereof, for example, thus suppressing contact between the electrical wires and another member.

For example, a plate-shaped protection member (corrugated plastic sheet) that supports an electrical wire bundle routed in a straight line is disclosed in an example shown in JP 2014-117099A. A structure in which the electrical wire bundle is placed on the plate-shaped protection member having a hollow structure is shown in the example in JP 2014-117099A.

### SUMMARY

With a structure in which an electrical wire bundle that includes a plurality of electrical wires or an electrical wire having a circular cross-sectional shape is placed on a protection member having a rectangular cross-sectional shape as in the example shown in JP 2014-117099A, the area of contact between the protection member and the electrical wires is relatively small. For this reason, even if a binding member such as tape is wrapped them, there is concern that the fixing of the protection member and the electrical wires easily becomes unstable.

An object of the present invention is to obtain more stable fixing of a protection member and an electrical wire in a wire module that includes a protection member having a hollow structure.

A wire module according to a first aspect includes: an electrical wire portion that includes at least one electrical wire; and a protection member that covers at least a portion of the electrical wire portion in a circumferential direction thereof, and is formed by a hollow plate member that includes a plurality of plate-shaped portions and an interposing portion that is arranged between the plurality of plate-shaped portions and forms a hollow space between the plurality of plate-shaped portion, wherein among the plurality of plate-shaped portions of the protection member, an innermost plate-shaped portion that comes into contact with the electrical wire portion is entirely curved in a shape that conforms to an outer circumferential surface of the electrical wire portion.

A wire module according to a second aspect is an aspect of the wire module according to the first aspect. In the wire module according to the second aspect, a curve forming portion for allowing curving of the protection member is formed in the protection member, and the curve forming portion includes a first slit that extends in an extending direction of the electrical wire portion and is formed in, among the plurality of plate-shaped portions, an outermost plate-shaped portion that is arranged on an outermost side relative to the innermost plate-shaped portion on an inward side.

A wire module according to a third aspect is an aspect of the wire module according to the first aspect. In the wire module according to the third aspect, a curve forming portion for allowing curving of the protection member is formed in the protection member, and the curve forming portion includes a recessed portion that is formed so as to extend in an extending direction of the electrical wire portion, and recedes in a direction opposite to an electrical wire portion side in the innermost plate-shaped portion.

A wire module according to a fourth aspect is an aspect of the wire module according to the second aspect or the third aspect. In the wire module according to the fourth aspect, the protection member includes a plurality of the interposing portions that are wall-shaped and formed so as to extend in the extending direction of the electrical wire portion, and the curve forming portion is formed in a portion between adjacent wall-shaped portions.

A wire module according to a fifth aspect is an aspect of the wire module according to the fourth aspect. In the wire module according to the fifth aspect, the protection member further includes a second slit that is formed so as to extend in a direction orthogonal to the extending direction of the electrical wire portion in, among the plurality of plate-shaped portions, an outermost plate-shaped portion that is arranged on an outermost side relative to the innermost plate-shaped portion on an inward side.

A wire module according to a sixth aspect is an aspect of the wire module according to the second aspect or the third aspect. In the wire module according to the sixth aspect, the protection member includes a plurality of the interposing portions that are wall-shaped and formed so as to extend in a direction orthogonal to the extending direction of the electrical wire portion.

### ADVANTAGEOUS EFFECTS OF INVENTION

In the above aspects, the innermost plate-shaped portion of the protection member is entirely curved in a shape that conforms to the outer circumferential surface of the electrical wire portion. In this case, it is possible to create a state in which the innermost plate-shaped portion of the protection member is entirely in contact with the electrical wire portion. For this reason, when a binding member for fixing the protection member and the electrical wire portion is wrapped, the fixed state of these members can be made more stable.

Also, in the second aspect, the curve forming portion that allows curving of the protection member includes the first slit that is formed in the outermost plate-shaped portion and extends in the extending direction of the electrical wire portion. In this case, the outermost plate-shaped portion can more easily deform so as to conform to the curved shape of the innermost plate-shaped portion, and the task of attaching the protection member to the electrical wire portion can therefore be performed relatively easily.

Also, in the third aspect, the curve forming portion that allows curving of the protection member includes the recessed portion that is formed in the innermost plate-shaped portion and extends in the extending direction of the electrical wire portion. In this case, when the protection member is in the curved state, the innermost plate-shaped portion and the plate-shaped portion located outward of the innermost plate-shaped portion constitute a protection layer for the electrical wire portion, thus making it possible to relatively improve the ability to protect the electrical wire portion.

Also, in the fourth aspect, the protection member includes a plurality of the interposing portions that are wall-shaped and formed so as to extend in the extending direction of the electrical wire portion, and the curve forming portion is formed in a portion between adjacent interposing portions. In this case, the protection member can easily maintain an aspect of being in a straight line shape extending along the extending direction of the electrical wire portion, thus making it possible to maintain the arranged aspect of the electrical wire portion arranged along a straight path.

Also, in the fifth aspect, the protection member includes the second slit that is formed so as to extend in a direction orthogonal to the extending direction of the electrical wire portion. In this case, in the portion where the second slit is formed, the protection member easily bends in the direction in which the plate-shaped portions are overlapped. For this reason, the wire module of the fifth aspect is relatively effective in the case where the electrical wire portion is arranged along a path that includes a straight portion and a bent portion.

Also, in the sixth aspect, the protection member includes a plurality of the interposing portions that are wall-shaped and formed so as to extend in a direction orthogonal to the extending direction of the electrical wire portion. In this case, the protection member can easily bend in the direction in which the plate-shaped portions are overlapped.

### BRIEF DESCRIPTION OF DRAWINGS

FIG. 1 is a partial cutaway perspective view of a wire module according to a first embodiment.

FIG. 2 is a cross-sectional view of the wire module according to the first embodiment.

FIG. 3 is a perspective view of a protection member of the wire module according to the first embodiment in a spread state.

FIG. 4 is a schematic view of a state in which the wire module according to the first embodiment is installed in a vehicle.

FIG. 5 is a cross-sectional view of a wire module according to a second embodiment.

FIG. 6 is a perspective view of a protection member of the wire module according to the second embodiment in a spread state.

FIG. 7 is a partial cutaway perspective view of a wire module according to a third embodiment.

FIG. 8 is a perspective view of a protection member of the wire module according to the third embodiment in a spread state.

FIG. 9 is a partial cutaway perspective view of a wire module according to a fourth embodiment.

FIG. 10 is a perspective view of a protection member of the wire module according to the fourth embodiment in a spread state.

### DETAILED DESCRIPTION OF PREFERRED EMBODIMENTS

Hereinafter, embodiments will be described with reference to the accompanying drawings. The following embodiments are examples of embodiments of the present invention, and are not intended to limit the technical scope of the present invention.

### First Embodiment

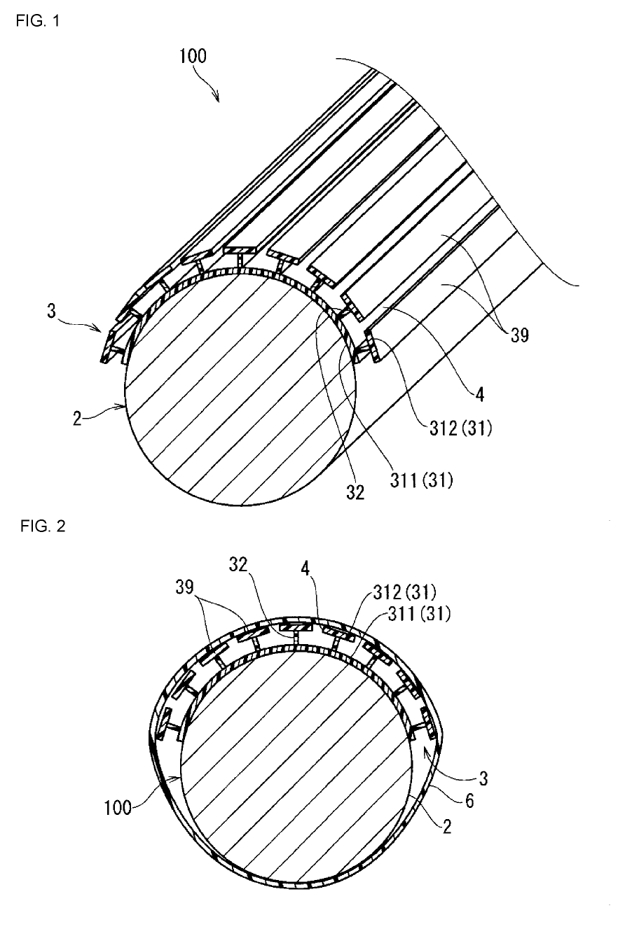

First, a wire module 100 of a first embodiment will be described with reference to FIGS. 1 to 4. The wire module 100 includes an electrical wire portion 2 and a protection member 3. The wire module 100 is for installation in a vehicle such as an automobile.

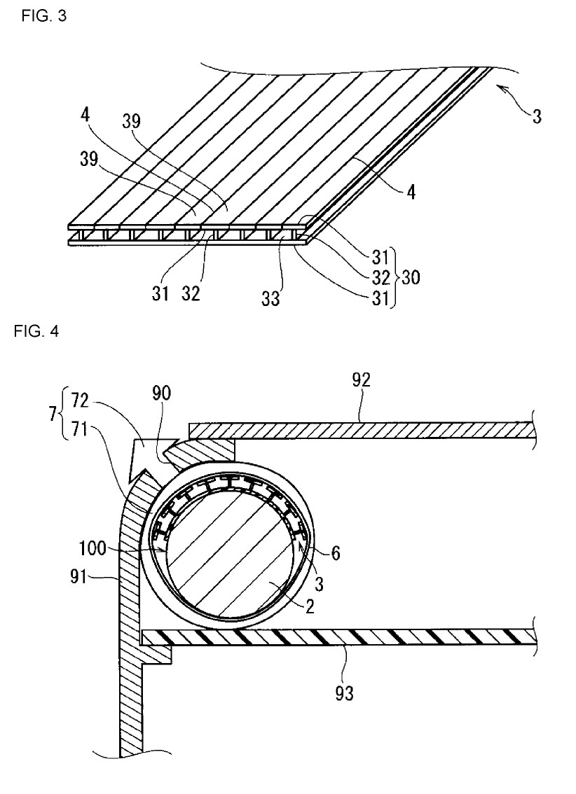

FIG. 1 is a partial cutaway perspective view of the wire module 100. FIG. 2 is a cross-sectional view of the wire module 100. Note that FIG. 2 shows a state in which a binding member 6 is wrapped around the wire module 100. FIG. 3 is a perspective view of the protection member 3 in a spread state. FIG. 4 is a cross-sectional view of the wire module 100 in a state of being installed in a vehicle.

Wire Module: Electrical Wire Portion

In the wire module 100, the electrical wire portion 2 includes at least one electrical wire. An insulated electrical wire that is constituted by a core wire and an insulating covering that surrounds the core wire may be included as an electrical wire included in the electrical wire portion 2. In this case, the core wire may be, for example, a member whose main component is a metal such as copper or aluminum. Also, the insulating covering may be, for example, a synthetic resin member whose main component is polyethylene, vinyl chloride, or the like.

Note that in the case where the electrical wire portion 2 includes a plurality of electrical wires, there are cases where these electrical wires are bundled in advance, and cases where they are not bundled.

Wire Module: Protection Member

In the wire module 100, the protection member 3 covers at least a portion of the electrical wire portion 2 in the circumferential direction thereof. FIGS. 1 and 2 show the case where the protection member 3 covers approximately half of the region of the electrical wire portion 2 in the circumferential direction.

As shown in FIG. 3, the protection member 3 is formed by a hollow plate member 30 that includes a plurality of plate-shaped portions 31 and interposing portions 32 that are arranged between the plate-shaped portions 31 and form hollow spaces 33 between the plate-shaped portions 31.

In the present embodiment, the hollow plate member 30 includes a plurality of the interposing portions 32 that are interposed in a parallel manner between two plate-shaped portions 31. The interposing portions 32 are arranged between two plate-shaped portions 31, in a parallel manner with spaces therebetween.

Also, in the present embodiment, the interposing portions 32 are shaped as walls. As shown in FIG. 3, the interposing portions 32 are each shaped as an elongated plate, and are arranged in a perpendicular orientation relative to the two plate-shaped portions 31. Also, end portions on one side of the interposing portions 32 are connected to one of the plate-shaped portions 31, and end portions on the other side are connected to the other plate-shaped portion 31. Accordingly, the two plate-shaped portions 31 and the interposing portions 32 are integrally connected so as to have a ladder-shaped cross-section in a plane that is orthogonal to the extending direction of the interposing portions 32.

Accordingly, a plurality of elongated hollow spaces 33 that are arranged in a parallel manner are formed in the hollow plate member 30 of the present embodiment. The hollow spaces 33 are each surrounded by the two plate-shaped portions 31 and two adjacent interposing portions 32. For this reason, the hollow spaces 33 have a quadrangular transverse sectional shape.

The hollow plate member 30 may be a member formed by a resin material. For example, the hollow plate member 30 may be formed by a corrugated plastic sheet that is made of a resin material such as polypropylene. In the case of manufacturing the hollow plate member 30 from a corrugated plastic sheet, the corrugated plastic sheet may be manufactured in a continuous manner using an extrusion molding device that extrudes resin from extrusion holes that correspond to the ladder-shaped cross-section, for example. Then the corrugated plastic sheet manufactured by the extrusion molding device may then be cut to a predetermined size to manufacture the hollow plate member 30. Accordingly, the hollow plate member 30 can be manufactured easily and at low cost. With this hollow plate member 30, the hollow structure is formed between the two plate-shaped portions 31, thus making it possible to commensurately reduce the weight and material cost. Note that the interposing portions 32 may be connected to the plate-shaped portions 31 by an adhesive, welding, or the like.

Also, the first embodiment is an example of the case where the hollow plate member 30 is attached to the electrical wire portion 2 such that the direction in which the interposing portions 32 of the hollow plate member 30 extend matches the extending direction of the electrical wire portion 2. In this case, the hollow plate member 30 does not easily bend in the direction in which the plate-shaped portions 31 are stacked, thus making it possible to maintain the path of the electrical wire portion 2 that is to be arranged along a straight path.

In the wire module 100, the hollow plate member 30 (protection member 3) is attached to the electrical wire portion 2, and an innermost plate-shaped portion 311, which is the one of the plurality of (two in the present embodiment) plate-shaped portions 31 of the protection member 3 that is in contact with the electrical wire portion 2, is entirely curved in a shape that conforms to the outer circumferential surface of the electrical wire portion 2. In other words, the state where the innermost plate-shaped portion 311 is entirely in contact with the electrical wire portion 2 is created in the wire module 100.

Here, in the case where the electrical wire portion 2 includes one electrical wire, the innermost plate-shaped portion 311 is curved along the outer circumferential surface of the electrical wire. Note that an electrical wire generally has a circular cross-sectional shape. For this reason, in this case, the innermost plate-shaped portion 311 may be curved in an arc along the outer circumferential surface of the electrical wire.

On the other hand, there are also cases where the electrical wire portion 2 includes a plurality of electrical wires. In such a case, the innermost plate-shaped portion 311 curves along the outer circumferential surface of the electrical wires that are in a bundled state. Accordingly, in the case where the cross-sectional shape of the bundle of electrical wires is a distorted circle, the innermost plate-shaped portion 311 may curve along the outer circumferential surface of the distorted circle-shaped bundle of electrical wires. Note that, when not integrated with the protection member 3, the electrical wires may be bundled or not bundled.

Also, in the present embodiment, curve forming portions for allowing curving of the protection member 3 are formed in the protection member 3. The first embodiment is an example of the case where the curve forming portions are first slits 4 that are formed in an outermost plate-shaped portion 312, which is the one of the plurality of (two in the present embodiment) plate-shaped portions 31 that is arranged on the outermost side relative to the innermost plate-shaped portion 311 on the inner side. In the wire module 100, by forming the curve forming portions in the protection member 3, the protection member 3 easily curves along the outer circumferential surface of the electrical wire portion 2.

The first slits 4 are slits that extend in the extending direction of the electrical wire portion 2. Also, the first slits 4 are formed in portions between adjacent interposing portions 32 in the protection member 3. The operation for forming the first slits 4 may be performed along with the operation in which the corrugated plastic sheet manufactured by the extrusion molding device is cut to a predetermined size, for example.

As shown in FIG. 2, a plurality of first slits 4 are formed in the protection member 3. In the present embodiment, a first slit 4 is formed in all of the portions that are between adjacent interposing portions 32 in the protection member 3. In this case, the protection member 3 more easily curves along the outer circumferential surface of the electrical wire portion 2.

In the present embodiment, due to forming the first slits 4 in the hollow plate member 30, the outermost plate-shaped portion 312 is divided into portions (hereinafter, partitioned portions 39) that each include a portion connected to a respective interposing portion 32. As shown in FIGS. 1 to 3, the partitioned portions 39 are each connected to one interposing portion 32. Also, in the hollow plate member 30, partitioned portions 39 that are adjacent to each other across a first slit 4 can deform so as to separate from each other.

Also, in the present embodiment, the first slits 4 formed in the hollow plate member 30 are linear slits. Specifically, the first slits 4 are slits that do not have width. However, the first slits 4 may be slits that have width.

In the wire module 100, when the hollow plate member 30 is attached to the electrical wire portion 2, the protection member 3 easily bends due to the opening of the first slits 4. More specifically, when the hollow plate member 30 provided with the first slits 4 is attached to the electrical wire portion 2, the innermost plate-shaped portion 311 of the protection member 3 curves so as to conform to the outer circumferential surface of the electrical wire portion 2. At this time, adjacent partitioned portions 39 that are divided by the first slits 4 deform so as to separate from each other, and thus the outermost plate-shaped portion 312 that is located outward of the innermost plate-shaped portion 311 deforms to a shape that is entirely curved in accordance with the curving of the innermost plate-shaped portion 311. Accordingly, in the present embodiment, due to forming the first slits 4, the protection member 3 can be allowed to easily curve along the outer circumferential surface of the electrical wire portion 2.

Also, the present embodiment describes the case where the hollow plate member 30 includes two plate-shaped portions 31, and the first slits 4 are formed in the plate-shaped portion 31 on the outer side (outermost plate-shaped portion 312). However, the hollow plate member 30 may include three or more plate-shaped portions 31. In this case, the first slits 4 may be formed in only the outermost plate-shaped portion 312 on the outermost side, or may be formed in each plate-shaped portion 31 other than the innermost plate-shaped portion 311.

Wire Module

As shown in FIG. 2, a binding member 6 such as a band or tape may be wrapped around the wire module 100 that includes the electrical wire portion 2 and the protection member 3. The binding member 6 may be provided so as to cover the periphery of the electrical wire 2 and the protection member 3, for example. The binding member 6 is a member for integrating the electrical wire portion 2 and the protection member 3.

FIG. 4 is a schematic view of a state in which the wire module 100 is installed in a vehicle. In the example shown in FIG. 4, a belt clamp 7 is attached to the wire module 100 with the binding member 6 wrapped thereon. Also, the wire module 100 is fixed to a plate-shaped metal plate member 91, which constitutes a portion of the vehicle body, by the belt clamp 7.

As shown in FIG. 4, the belt clamp 7 includes a belt portion 71 that is wrapped around the wire module 100, and a clamp portion 72 that is fixed by being inserted into a hole 90 formed in the metal plate member 91. Note that the hole 90 is a through-hole that penetrates from one surface of the metal plate member 91 to the other surface.

The example shown in FIG. 4 is an example of the case where the wire module 100 is arranged on a portion where two metal plate members 91 and 92 meet. In the case of this arrangement location, if there is a risk that the corner of one of the two metal plate members 91 and 92 (in the example shown in FIG. 4, the metal plate member 91) comes into contact with the electrical wire portion 2, there is concern of the electrical wire portion 2 becoming damaged. In this case, the wire module 100 includes the protection member 3 that covers at least a portion of the electrical wire portion 2 in the circumferential direction thereof, thus making it possible to suppress the case where the electrical wire portion 2 comes into contact with the corner of the metal plate member 91 and the electrical wire portion 2 becomes damaged.

Note that in the example shown in FIG. 4, the wire module 100 is arranged on a portion that is surrounded by the metal plate member 91, metal plate member 92, and a plate member 93. In the example shown in FIG. 4, the metal plate member 91 may be a door panel of the vehicle body, for example. Also, the metal plate member 92 may be a roof panel of the vehicle body, for example. Furthermore, the plate member 93 may be a resin member that forms a ceiling portion of the interior of the vehicle body.

In the present embodiment, the innermost plate-shaped portion 311 of the protection member 3 is entirely curved in a shape that conforms to the outer circumferential surface of the electrical wire portion 2. In this case, it is possible to create a state in which the innermost plate-shaped portion 311 of the protection member 3 is entirely in contact with the electrical wire portion 2. For this reason, when the binding member 6 for fixing the protection member 3 and the electrical wire portion 2 is wrapped, the fixed state of these members can be made more stable.

In the present embodiment, the innermost plate-shaped portion 311 of the protection member 3 is entirely curved in a shape that conforms to the outer circumferential surface of the electrical wire portion 2. For this reason, even if electrical wires are not bundled in advance, it is possible to suppress the case where the electrical wires come apart. In other words, the innermost plate-shaped portion 311 of the protection member 3 curves along and covers the outer circumferential surface of the electrical wire portion 2, thus making it possible to suppress the case where the electrical wires come apart.

Also, in the present embodiment, the curve forming portions that allow curving of the protection member 3 include the first slits 4 that are formed in the outermost plate-shaped portion 312 and extend in the extending direction of the electrical wire portion 2. In this case, the outermost plate-shaped portion 312 can more easily deform so as to conform to the curved shape of the innermost plate-shaped portion 311, and the task of attaching the protection member 3 to the electrical wire portion 2 can therefore be performed relatively easily.

Also, in the present embodiment, the protection member 3 includes a plurality of the wall-shaped interposing portions 32 that are formed so as to extend in the extending direction of the electrical wire portion 2, and the curve forming portions (first slits 4) are formed in portions between adjacent interposing portions 32. In this case, the protection member 3 can easily maintain an aspect of being in a straight line shape extending along the extending direction of the electrical wire portion 2, thus making it possible to maintain the arranged aspect of the electrical wire portion 2 arranged along a straight path.

### Second Embodiment

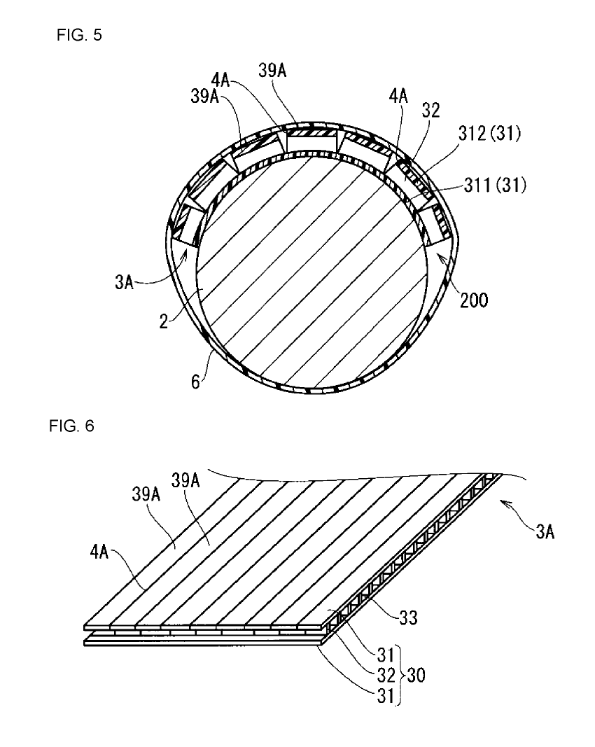

Next, a wire module 200 according to a second embodiment will be described with reference to FIGS. 5 and 6. The wire module 200 includes a protection member 3A that has a different structure from the protection member 3. FIG. 5 is a cross-sectional view of the wire module 200. FIG. 6 is a perspective view of the protection member 3A in a spread state. Note that constituent elements in FIGS. 5 and 6 that are the same as constituent elements shown in FIGS. 1 to 4 are denoted by the same reference signs. The following describes differences from the first embodiment.

In the present embodiment, the wire module 200 includes the electrical wire portion 2 and the protection member 3A. The electrical wire portion 2 has the same structure as in the first embodiment, and therefore will not be described.

Similarly to the first embodiment, the protection member 3A is formed by the hollow plate member 30 that includes a plurality of (two in the present embodiment) the plate-shaped portions 31 and the interposing portions 32 that are interposed between the plate-shaped portions 31. The hollow plate member 30 is similar to that in the first embodiment, and therefore will not be described.

The second embodiment is an example of the case where the protection member 3A is attached to the electrical wire portion 2 such that the direction in which the interposing portions 32 of the hollow plate member 30 extend is orthogonal to the extending direction of the electrical wire portion 2. Specifically, in the wire module 200, the protection member 3A includes a plurality of wall-shaped interposing portions 32 that are formed so as to extend in a direction orthogonal to the extending direction of the electrical wire portion 2. Note that the interposing portions 32 are arranged side-by-side along the extending direction of the electrical wire portion 2 with spaces therebetween.

In the present embodiment, first slits 4A are formed in the protection member 3A as the curve forming portions for allowing the protection member 3A to curve. Unlike the first embodiment, the first slits 4A are slits formed so as to extend in the direction in which the interposing portions 32 are arranged side-by-side. Accordingly, the first slits 4A are formed so as to extend in the extending direction of the electrical wire portion 2 while crossing the interposing portions 32.

Also, in the present embodiment, the protection member 3A includes a plurality of the first slits 4A. As shown in FIG. 6, the first slits 4A are formed with spaces therebetween along the direction in which the interposing portions 32 extend.

As shown in FIG. 5, the first slits 4A are formed extending from the outermost plate-shaped portion 312 to the innermost plate-shaped portion 311 side, and are formed in the interposing portions 32 as well. It is preferable that the first slits 4A are slits that reach the base portions of the interposing portions 32 that are connected to the innermost plate-shaped portion 311.

In the protection member 3A, a plurality of partitioned portions 39A that include the outermost plate-shaped portion 312 and the interposing portions 32 are divided by the first slits 4A. In the second embodiment, adjacent partitioned portions 39A among the plurality of partitioned portions 39A are able to deform so as to separate from each other in accordance with bending of the innermost plate-shaped portion 311.

In the case where the first slits 4A are formed so as to reach the base of the interposing portions 32, the innermost plate-shaped portion 311 can be considered to one plate-shaped portion 31 in the portion where the first slits 4A are formed. The plate-shaped portion 31 is a relatively thin portion, and therefore the innermost plate-shaped portion 311 can easily bend at the locations where the first slits 4A are formed. Accordingly, the protection member 3A more easily curves along the outer circumferential surface of the electrical wire portion 2.

Note that the first slits 4A may be slits that extend from the outermost plate-shaped portion 312 to intermediate portions of the interposing portions 32.

In the present embodiment as well, the innermost plate-shaped portion 311 of the protection member 3A is entirely curved in a shape that conforms to the outer circumferential surface of the electrical wire portion 2, and therefore when the binding member for fixing the protection member 3A and the electrical wire portion 2 is wrapped, the fixed state of these members can be made more stable.

Also, in the present embodiment, the protection member 3A has a structure in which a plurality of the interposing portions 32 are arranged side-by-side along the extending direction of the electrical wire portion 2, and therefore the protection member 3A easily bends in the stacking direction of the plurality of (two in the present embodiment) plate-shaped portions 31. In other words, the protection member 3A can easily bend in the direction in which the plate-shaped portions 31 are overlapped. Accordingly, the wire module 200 is effective in the case where the electrical wire portion 2 is arranged along a bent path.

### Third Embodiment

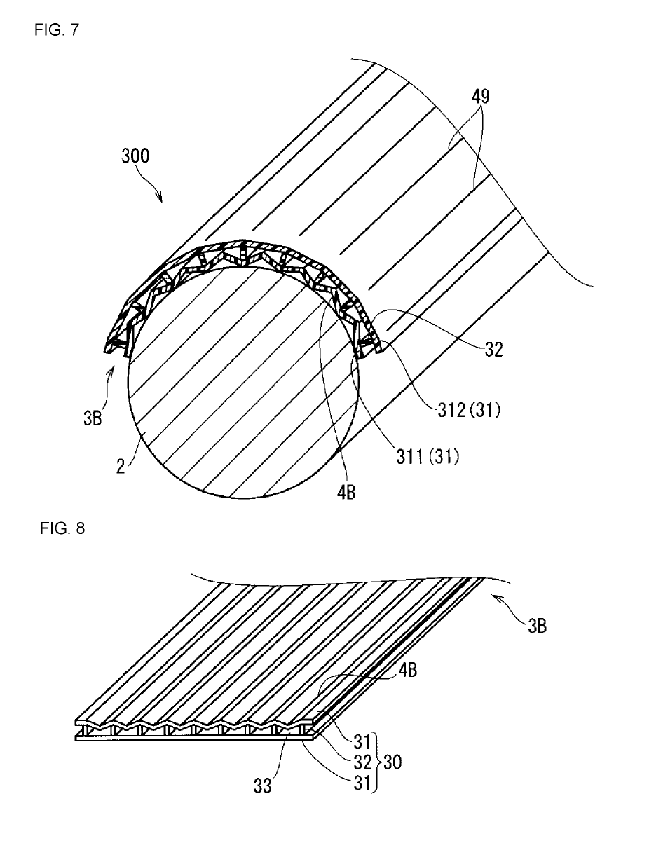

Next, a wire module 300 according to a third embodiment will be described with reference to FIGS. 7 and 8. The wire module 300 includes a protection member 3B that has a different structure from the protection members 3 and 3A. FIG. 7 is a partial cutaway perspective view of the wire module 300. FIG. 8 is a perspective view of the protection member 3B in a spread state. Note that constituent elements in FIGS. 7 and 8 that are the same as constituent elements shown in FIGS. 1 to 6 are denoted by the same reference signs. The following describes differences from the first embodiment and the second embodiment.

In the present embodiment, the wire module 300 includes the electrical wire portion 2 and the protection member 3B. The electrical wire portion 2 has the same structure as in the first embodiment, and therefore will not be described.

Similarly to the first embodiment, the protection member 3B is formed by the hollow plate member 30 that includes a plurality of (two in the present embodiment) the plate-shaped portions 31 and the interposing portions 32 that are interposed between the plate-shaped portions 31. The hollow plate member 30 is similar to that in the first embodiment, and therefore will not be described.

Similarly to the first embodiment, the third embodiment is an example of the case in which the protection member 3B is attached to the electrical wire portion 2 such that the direction in which the interposing portions 32 of the hollow plate member 30 extend matches the extending direction of the electrical wire portion 2.

Also, in the present embodiment, the curve forming portions of the protection member 3B for allowing curving of the protection member 3B include recessed portions 4B. As shown in FIG. 7, the recessed portions 4B are formed in the innermost plate-shaped portion 311. The recessed portions 4B are formed so as to recede in the direction opposite to the electrical wire portion 2 side of the innermost plate-shaped portion 311.

As shown in FIGS. 7 and 8, in the present embodiment, the recessed portions 4B include two flat surfaces that are connected at an angle. In other words, the recessed portions 4B are formed with a V-shaped cross-sectional shape. However, the recessed portions 4B may include a surface that has a smooth receding shape, or may include three flat surfaces that are connected at right angles.

Also, the recessed portions 4B are formed so as to extend in the extending direction of the electrical wire portion 2. In other words, the recessed portions 4B are formed so as to extend in the direction in which the interposing portions 32 extend. Also, the recessed portions 4B are formed in portions between adjacent interposing portions 32 (wall-shaped portions) in the protection member 3B. The recessed portions 4B may be formed by performing pressing along with the operation in which a corrugated plastic sheet manufactured by an extrusion molding device is cut to a predetermined size, for example.

In the present embodiment, a plurality of the recessed portions 4B are formed in the protection member 3B. The recessed portions 4B are respectively formed in all of the portions that are located between adjacent interposing portions 32 in the protection member 3B. In this case, the protection member 3B more easily curves along the outer circumferential surface of the electrical wire portion 2.

In the present embodiment, when the hollow plate member 30 provided with the recessed portions 4B is attached to the electrical wire portion 2, the innermost plate-shaped portion 311 provided with the recessed portions 4B easily deforms into a curved shaped due to bending such that the widths of the recessed portions 4B decrease. Accordingly, the protection member 3B more easily bends into a shape that conforms to the outer circumferential surface of the electrical wire portion 2.

Note that as shown in FIG. 7, creases 49 may be formed in the protection member 3B that is in the state of being attached to the electrical wire portion 2. The creases 49 are formed in portions of the outermost plate-shaped portion 312 that are connected to the interposing portions 32. Also, the creases 49 may be provided in advance in the portions of the outermost plate-shaped portion 312 that are connected to the interposing portions 32. In this case, the creases 49 may be linear grooves that recede toward the innermost plate-shaped portion 311 side.

In the present embodiment as well, the innermost plate-shaped portion 311 of the protection member 3B is entirely curved in a shape that conforms to the outer circumferential surface of the electrical wire portion 2, and therefore when the binding member for fixing the protection member 3B and the electrical wire portion 2 is wrapped, the fixed state of these members can be made more stable.

Also, in the present embodiment, the curve forming portions that allow curving of the protection member 3B include the recessed portions 4B that are formed in the innermost plate-shaped portion 311 and extend in the extending direction of the electrical wire portion 2. In this case, when the protection member 3B is in the curved state, the innermost plate-shaped portion 311 and the plate-shaped portion (the outermost plate-shaped portion 312 in the present embodiment) that is located outward of the inner plate-shaped portion 311 constitute a layer that protects the electrical wire portion 2. For this reason, the electrical wire portion 2 can be protected by relatively more layers (plate-shaped portions 31), and protection capability can be improved.

### Fourth Embodiment

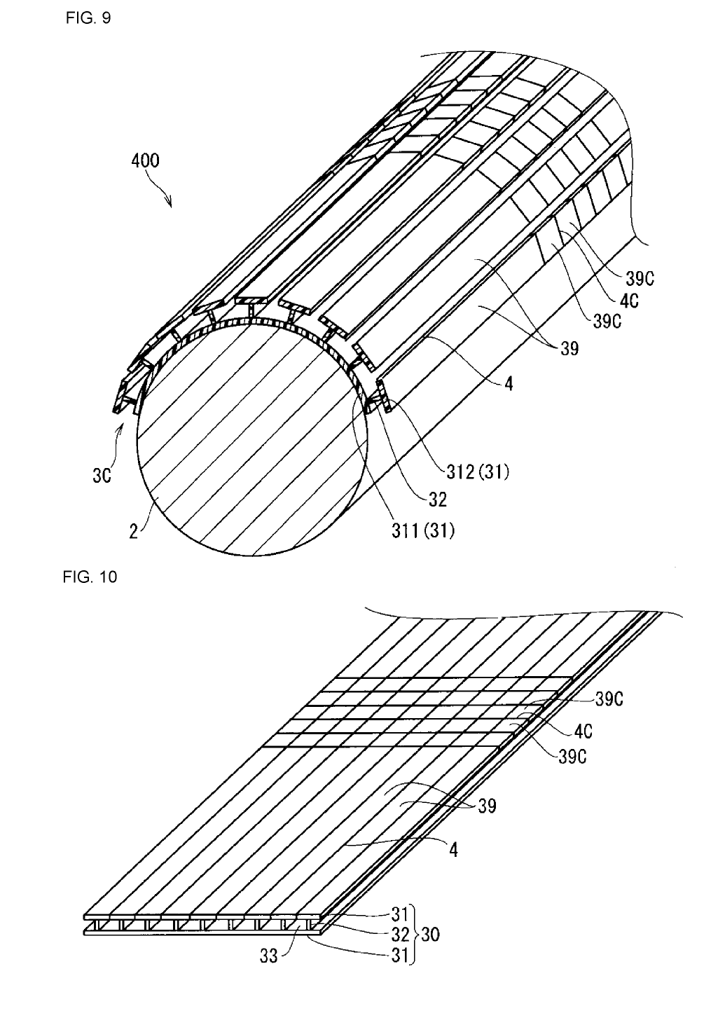

Next, a wire module 400 according to a fourth embodiment will be described with reference to FIGS. 9 and 10. The wire module 400 includes a protection member 3C that has a different structure from the protection members 3, 3A, and 3B. FIG. 9 is a partial cutaway perspective view of the wire module 400. FIG. 10 is a perspective view of the protection member 3C in a spread state. Note that constituent elements in FIGS. 9 and 10 that are the same as constituent elements shown in FIGS. 1 to 8 are denoted by the same reference signs. The following describes differences from the first embodiment, the second embodiment, and the third embodiment.

In the present embodiment, the wire module 400 includes the electrical wire portion 2 and the protection member 3C. The electrical wire portion 2 has the same structure as in the first embodiment, and therefore will not be described.

Similarly to the first embodiment, the protection member 3C is formed by the hollow plate member 30 that includes a plurality of (two in the present embodiment) the plate-shaped portions 31 and the interposing portions 32 that are interposed between the plate-shaped portions 31. The hollow plate member 30 is similar to that in the first embodiment, and therefore will not be described.

Similarly to the first embodiment, the fourth embodiment is an example of the case in which the protection member 3C is attached to the electrical wire portion 2 such that the direction in which the interposing portions 32 of the hollow plate member 30 extend matches the extending direction of the electrical wire portion 2. Also, similarly to the first embodiment, the fourth embodiment is an example of the case in which the curve forming portions for allowing curving of the protection member 3C are the first slits 4. The first slits 4 are similar to those in the first embodiment, and therefore will not be described.

In the present embodiment, the protection member 3C further includes second slits 4C that are formed in, among the plurality of (two in the present embodiment) plate-shaped portions 31, the outermost plate-shaped portion 312 that is arranged on the outermost side relative to the innermost plate-shaped portion 311 on the inward side, and that are formed so as to extend in a direction orthogonal to the extending direction of the electrical wire portion 2.

Specifically, the protection member 3C includes the first slits 4 that extend in the extending direction of the electrical wire portion 2 (the extending direction of the interposing portions 32), and the second slits 4C that extend in a direction orthogonal to the extending direction of the electrical wire portion 2 (in the direction in which the interposing portions 32 are arranged side-by-side). Note that in the wire module 400, the direction orthogonal to the extending direction of the electrical wire portion 2 matches the circumferential direction of the electrical wire portion 2.

As shown in FIGS. 9 and 10, in the present embodiment, the second slits 4C are formed so as to extend in the direction in which the interposing portions 32 are arranged side-by-side, and are formed so as to cross the interposing portions 32. Also, in the present embodiment, the protection member 3C includes a plurality of the second slits 4C. The second slits 4C are formed so as to be arranged side-by-side along the extending direction of the electrical wire portion 2 with gaps therebetween.

It is preferable that the second slits 4C are slits that are formed so as to extend from the outermost plate-shaped portion 312 to the innermost plate-shaped portion 311 side, and reach the base portions of the interposing portions 32 that are connected to the innermost plate-shaped portion 311. Note that the second slits 4C may be slits that extend from the outermost plate-shaped portion 312 to intermediate portions of the interposing portions 32.

In the present embodiment, due to the second slits 4C, the outermost plate-shaped portion 312 of the protection member 3C is divided into portions (partitioned portions 39C) in the extending direction of the electrical wire portion 2 as well. The partitioned portions 39C divided by the second slits 4C can deform such that adjacent partitioned portions 39C separate from each other. Accordingly, in the present embodiment, the protection member 3C can bend in the direction in which the second slits 4C open, that is to say the direction from the outermost plate-shaped portion 312 side to the innermost plate-shaped portion 311 side. Note that the protection member 3C can be maintained in a straight line shape in the portions where the second slits 4C are not formed.

In the present embodiment as well, the innermost plate-shaped portion 311 of the protection member 3C is entirely curved in a shape that conforms to the outer circumferential surface of the electrical wire portion 2, and therefore when the binding member for fixing the protection member 3C and the electrical wire portion 2 is wrapped, the fixed state of these members can be made more stable.

Also, in the present embodiment, the protection member 3C includes the second slits 4C that are formed so as to extend in a direction orthogonal to the extending direction of the electrical wire portion 2. In this case, in the portion in which the second slits 4C are formed, the protection member 3C easily bends in the direction in which the plate-shaped portions 31 are overlapped. For this reason, the wire module 400 is relatively effective in the case where the electrical wire portion 2 is arranged along a path that includes a straight portion and a bent portion.

Application Examples

A combined structure including the first slits 4 and the recessed portions 4B is also possible. In other words, the curve forming portion may include both the first slits 4 and the recessed portions 4B.

The second slits 4C may be formed in the protection member 3B that includes the recessed portions 4B.

The second slits 4C that are orthogonal to the extending direction of the electrical wire portion 2 may be formed between the interposing portions 32 of the protection member 3A.

The recessed portions 4B may be formed instead of the first slits 4A in the protection member 3A.

At least one of the plate-shaped portions 31 and the interposing portions 32 may be formed by one sheet of paper. Note that in this case, it is preferable that the surface is subjected to water repellency processing or the like.

In the hollow plate member 30, the interposing portions 32, which are interposed between the plate-shaped portions 31 and form the hollow structure, may form a different hollow shape. For example, the interposing portions 32 between the plate-shaped portions 31 may form a hollow structure that is shaped as a polygonal column, such as a triangular column, or may form a honeycomb structure in particular.

Note that in the wire module according to the present invention, the embodiments and application examples described above can be freely combined, and modifications or partial omissions may be appropriately applied to the embodiments and application examples, within the scope of the invention described in the claims.

1. A wire module comprising:
an electrical wire portion that includes at least one electrical wire; and
a protection member that covers at least a portion of the electrical wire portion in a circumferential direction thereof, and is formed by a hollow plate member that includes a plurality of plate-shaped portions and an interposing portion that is arranged between the plurality of plate-shaped portions and forms a hollow space between the plurality of plate-shaped portion,
wherein among the plurality of plate-shaped portions of the protection member, an innermost plate-shaped portion that comes into contact with the electrical wire portion is entirely curved in a shape that conforms to an outer circumferential surface of the electrical wire portion.

2. The wire module according to claim 1,
wherein a curve forming portion for allowing curving of the protection member is formed in the protection member, and
the curve forming portion includes a first slit that extends in an extending direction of the electrical wire portion and is formed in, among the plurality of plate-shaped portions, an outermost plate-shaped portion that is arranged on an outermost side relative to the innermost plate-shaped portion on an inward side.

3. The wire module according to claim 1,
wherein a curve forming portion for allowing curving of the protection member is formed in the protection member, and
the curve forming portion includes a recessed portion that is formed so as to extend in an extending direction of the electrical wire portion, and recedes in a direction opposite to an electrical wire portion side in the innermost plate-shaped portion.

4. The wire module according to claim 2,
wherein the protection member includes a plurality of the interposing portions that are wall-shaped and formed so as to extend in the extending direction of the electrical wire portion, and
the curve forming portion is formed in a portion between adjacent wall-shaped portions.

5. The wire module according to claim 4, wherein the protection member further includes a second slit that is formed so as to extend in a direction orthogonal to the extending direction of the electrical wire portion in, among the plurality of plate-shaped portions, an outermost plate-shaped portion that is arranged on an outermost side relative to the innermost plate-shaped portion on an inward side.

6. The wire module according to claim 2, wherein the protection member includes a plurality of the interposing portions that are wall-shaped and formed so as to extend in a direction orthogonal to the extending direction of the electrical wire portion.

7. The wire module according to claim 3, wherein the protection member includes a plurality of the interposing portions that are wall-shaped and formed so as to extend in the extending direction of the electrical wire portion, and the curve forming portion is formed in a portion between adjacent wall-shaped portions.

8. The wire module according to claim 3, wherein the protection member includes a plurality of the interposing portions that are wall-shaped and formed so as to extend in a direction orthogonal to the extending direction of the electrical wire portion.
